(19) United States
(12) Patent Application Publication
(10) Pub. No.: US 2018/0233942 A1
(43) Pub. Date: Aug. 16, 2018

(54) Wireless Charging System With Protection Circuitry

(71) Applicant: Apple Inc., Cupertino, CA (US)

(72) Inventors: Weihong Qiu, San Ramon, CA (US); Mehmet K. Nalbant, Cupertino, CA (US); Zaki Moussaoui, San Carlos, CA (US)

(21) Appl. No.: 15/655,628

(22) Filed: Jul. 20, 2017

Related U.S. Application Data
(60) Provisional application No. 62/457,736, filed on Feb. 10, 2017.

(51) Int. Cl. H02J 7/02; H02J 50/12

(52) U.S. Cl. CPC H02J 7/027; H02J 50/12; H02J 7/025

(57) ABSTRACT

A wireless power transmitting device transmits wireless power signals to a wireless power receiving device. The wireless power receiving device has a rectifier and a wireless power receiving coil that receives wireless power signals. The rectifier is coupled to an integrated circuit such as a battery charger integrated circuit. One or more capacitors are coupled between input terminals for the rectifier and the wireless power receiving coil. The rectifier has output terminals at which the rectifier provides direct-current output power corresponding to the wireless power signals received with the wireless power receiving coil. Protection circuitry is coupled to one or more nodes located between the wireless power receiving coil and the capacitors. Control circuitry turns on one or more transistors in the protection circuitry in response to measurements made with sensor circuitry coupled to the output terminals.

This application claims the benefit of provisional patent application No. 62/457,736 filed on Feb. 10, 2017, which is hereby incorporated by reference herein in its entirety.

### FIELD

This relates generally to wireless systems, and, more particularly, to systems in which devices are wirelessly charged.

### BACKGROUND

In a wireless charging system, a wireless power transmitting device such as a device with a charging surface wirelessly transmits power to a portable electronic device. The portable electronic device receives the wirelessly transmitted power and uses this power to charge an internal battery and to power components in the portable electronic device. It can be challenging to regulate the flow of wireless power in a wireless charging system. If care is not taken, unexpected changes in coupling between a wireless power receiving device and a wireless power transmitting device may cause undesired surges in the voltages and currents in a wireless power receiving device.

### SUMMARY

A wireless power transmitting device transmits wireless power signals to a wireless power receiving device using a wireless power transmitting coil. The wireless power receiving device has a wireless power receiving coil that receives the transmitted wireless power signals.

The wireless power receiving device has a rectifier. The rectifier is coupled to a load such as a battery charger integrated circuit that charges a battery in the wireless power receiving device.

The rectifier may have input terminals that receive alternating-current signals from the wireless power receiving coil and output terminals at which a corresponding direct-current output is supplied.

Capacitors are coupled between the input terminals of the rectifier and the wireless power receiving coil. Protection circuitry is coupled to one or more nodes that are located between the wireless power receiving coil and the capacitors. Sensor circuitry is coupled to the output terminals of the rectifier. The protection circuitry includes one or more transistors.

During operation, control circuitry receives output signal measurements from the sensor circuitry. In response to determining that a signal measurement such as a voltage measurement has exceeded a predetermined threshold value, the control circuitry turns on one or more of the transistors in the protection circuitry to prevent excessive current from flowing through the wireless power receiving coil and to prevent excessive voltages from developing across the capacitors.

### BRIEF DESCRIPTION OF THE DRAWINGS

FIG. 1 is a schematic diagram of an illustrative wireless charging system in accordance with embodiments.

FIG. 2 is a top view of an illustrative wireless power transmitting device with an array of coils that forms a wireless charging surface in accordance with an embodiment.

FIG. 3 is a circuit diagram of an illustrative wireless charging system in accordance with an embodiment.

FIG. 4 is a circuit diagram of an illustrative rectifier in accordance with an embodiment.

FIGS. 5, 6, 7, 8, 9, 10, 11, 12, and 13 are circuit diagrams of illustrative protection circuitry in accordance with embodiments.

### DETAILED DESCRIPTION

A wireless power system has a wireless power transmitting device that transmits power wirelessly to a wireless power receiving device. The wireless power transmitting device is a device such as a wireless charging mat, wireless charging puck, wireless charging stand, wireless charging table, or other wireless power transmitting equipment. The wireless power transmitting device has one or more coils that are used in transmitting wireless power to one or more wireless power receiving coils in the wireless power receiving device. The wireless power receiving device is a device such as a cellular telephone, watch, media player, tablet computer, pair of earbuds, remote control, laptop computer, other portable electronic device, or other wireless power receiving equipment.

During operation, the wireless power transmitting device supplies alternating-current drive signals to one or more wireless power transmitting coils. This causes the coils to transmit alternating-current electromagnetic signals (sometimes referred to as wireless power signals) to one or more corresponding coils in the wireless power receiving device. Rectifier circuitry in the wireless power receiving device converts received wireless power signals into direct-current (DC) power for powering the wireless power receiving device.

Electromagnetic coupling (coupling coefficient k) between the coils of the wireless power transmitting device and wireless power receiving device can vary during operation of the wireless power transfer system. For example, a user of a wireless power receiving device may inadvertently move the wireless power receiving device across a wireless power charging surface or may abruptly remove an object that is holding the transmitting and receiving devices apart. This type of inadvertent movement can cause a wireless power receiving coil in the wireless power receiving device to suddenly change its coupling with a wireless power transmitting coil in the wireless power transmitting device. If care is not taken, abrupt changes in coupling can cause undesired surges in the voltages and currents in the wireless power receiving device. Surge protection circuitry is therefore incorporated into the wireless power receiving device. The protection circuitry includes field-effect transistors or other switching circuits that are actively controlled based on measurements from sensor circuitry to prevent circuit damage in the event of an unexpected change in wireless coupling.

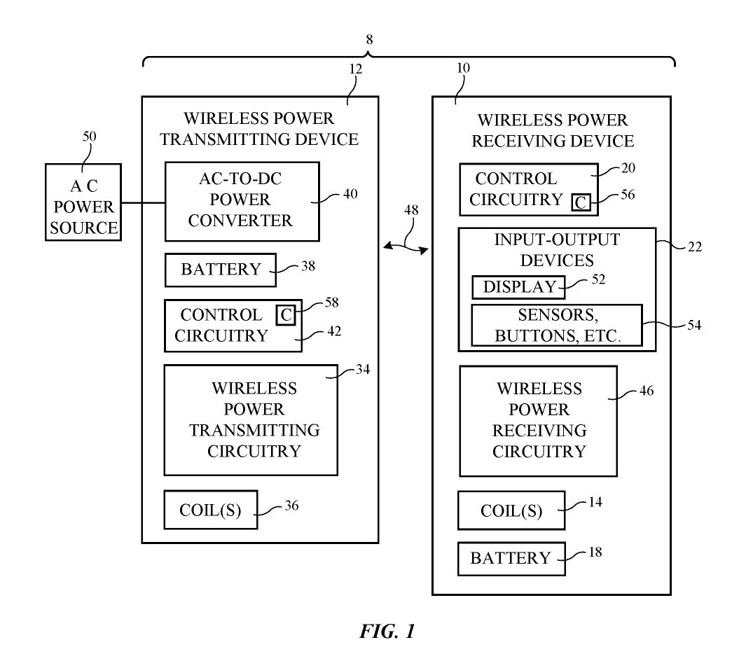

An illustrative wireless power system (wireless charging system) is shown in FIG. 1. As shown in FIG. 1, wireless power system 8 includes wireless power transmitting device 12 and one or more wireless power receiving devices such as wireless power receiving device 10. Device 12 may be a stand-alone device such as a wireless charging mat, may be built into furniture, or may be other wireless charging equipment. Device 10 is a portable electronic device such as a wristwatch, a cellular telephone, a tablet computer, or other electronic equipment. Illustrative configurations in which device 12 is a mat or other equipment that forms a wireless charging surface and in which device 10 is a portable electronic device that rests on the wireless charging surface during wireless power transfer operations are sometimes be described herein as examples.

During operation of system 8, a user places one or more devices 10 on the charging surface of device 12. Power transmitting device 12 is coupled to a source of alternating-current voltage such as alternating-current power source 50 (e.g., a wall outlet that supplies line power or other source of mains electricity), has a battery such as battery 38 for supplying power, and/or is coupled to another source of power. A power converter such as alternating-current-to-direct current (AC-DC) power converter 40 can convert power from a mains power source or other alternating-current (AC) power source into direct-current (DC) power that is used to power control circuitry 42 and other circuitry in device 12. During operation, control circuitry 42 uses wireless power transmitting circuitry 34 and one or more coil(s) 36 coupled to circuitry 34 to transmit alternating-current electromagnetic signals 48 to device 10 and thereby convey wireless power to wireless power receiving circuitry 46 of device 10.

Power transmitting circuitry 34 has switching circuitry (e.g., transistors in an inverter circuit) that are turned on and off based on control signals provided by control circuitry 42 to create AC signals (drive signals) through coil(s) 36. As the AC signals pass through coil(s) 36, alternating-current electromagnetic fields (wireless power signals 48) are produced that are received by corresponding coil(s) 14 coupled to wireless power receiving circuitry 46 in receiving device 10. When the alternating-current electromagnetic fields are received by coil 14, corresponding alternating-current currents and voltages are induced in coil 14. Rectifier circuitry in circuitry 46 converts received AC signals (received alternating-current currents and voltages associated with wireless power signals) from coil(s) 14 into DC voltage signals for powering device 10. The DC voltages are used in powering components in device 10 such as display 52, touch sensor components and other sensors 54 (e.g., accelerometers, force sensors, temperature sensors, light sensors, pressure sensors, gas sensors, moisture sensors, magnetic sensors, etc.), wireless communications circuits 56 for communicating wirelessly with corresponding wireless communications circuitry 58 in control circuitry 42 of wireless power transmitting device 12 and/or other equipment, audio components, and other components (e.g., input-output devices 22 and/or control circuitry 20) and are used in charging an internal battery in device 10 such as battery 18.

Devices 12 and 10 include control circuitry 42 and 20. Control circuitry 42 and 20 includes storage and processing circuitry such as microprocessors, power management units, baseband processors, digital signal processors, microcontrollers, and/or application-specific integrated circuits with processing circuits. Control circuitry 42 and 20 is configured to execute instructions for implementing desired control and communications features in system 8. For example, control circuitry 42 and/or 20 may be used in determining power transmission levels, processing sensor data, processing user input, processing other information such as information on wireless coupling efficiency from transmitting circuitry 34, processing information from receiving circuitry 46, using information from circuitry 34 and/or 46 such as signal measurements on output circuitry in circuitry 34 and other information from circuitry 34 and/or 46 to determine when to start and stop wireless charging operations, adjusting charging parameters such as charging frequencies, coil assignments in a multi-coil array, and wireless power transmission levels, and performing other control functions. Control circuitry 42 and 20 may be configured to support wireless communications between devices 12 and 10 (e.g., control circuitry 20 may include wireless communications circuitry such as circuitry 56 and control circuitry 42 may include wireless communications circuitry such as circuitry 58). Control circuitry 42 and/or 20 may be configured to perform these operations using hardware (e.g., dedicated hardware or circuitry) and/or software (e.g., code that runs on the hardware of system 8). Software code for performing these operations is stored on non-transitory computer readable storage media (e.g., tangible computer readable storage media). The software code may sometimes be referred to as software, data, program instructions, instructions, or code. The non-transitory computer readable storage media may include non-volatile memory such as non-volatile random-access memory (NVRAM), one or more hard drives (e.g., magnetic drives or solid state drives), one or more removable flash drives or other removable media, other computer readable media, or combinations of these computer readable media or other storage. Software stored on the non-transitory computer readable storage media may be executed on the processing circuitry of control circuitry 42 and/or 20. The processing circuitry may include application-specific integrated circuits with processing circuitry, one or more microprocessors, or other processing circuitry.

Device 12 and/or device 10 may communicate wirelessly during operation of system 8. Devices 10 and 12 may, for example, have wireless transceiver circuitry in control circuitry 42 and 20 (see, e.g., wireless communications circuitry such as circuitry 58 and 56 of FIG. 1) that allows wireless transmission of signals between devices 10 and 12 (e.g., using antennas that are separate from coils 36 and 14 to transmit and receive unidirectional or bidirectional wireless signals, using coils 36 and 14 to transmit and receive unidirectional or bidirectional wireless signals, etc.).

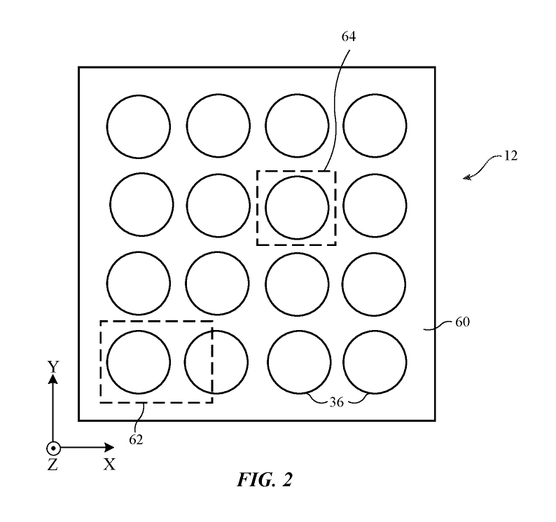

With one illustrative configuration, wireless transmitting device 12 is a wireless charging mat or other wireless power transmitting equipment that has an array of coils 36 that supply wireless power over a wireless charging surface. This type of arrangement is shown in FIG. 2. In the example of FIG. 2, device 12 has an array of coils 36 that lie in the X-Y plane. Coils 36 of device 12 are covered by a planar dielectric structure such as a plastic member or other structure forming charging surface 60. The lateral dimensions (X and Y dimensions) of the array of coils 36 in device 36 may be 1-1000 cm, 5-50 cm, more than 5 cm, more than 20 cm, less than 200 cm, less than 75 cm, or other suitable size. Coils 36 may overlap or may be arranged in a non-overlapping configuration. Coils 36 can be placed in a rectangular array having rows and columns and/or may be tiled using a hexagonal tile pattern or other pattern.

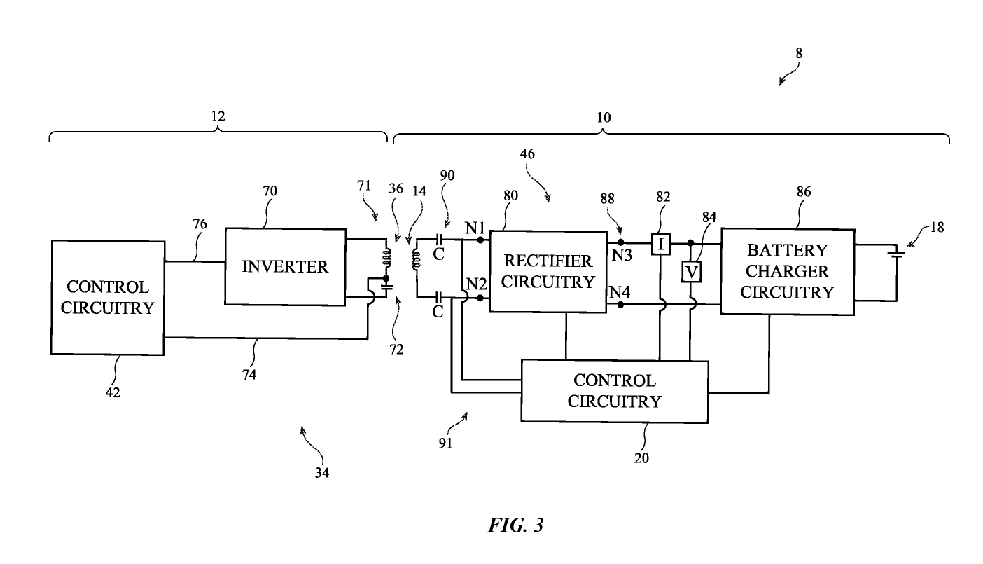

A circuit diagram of illustrative circuitry for wireless power transfer (wireless power charging) system 8 is shown in FIG. 3. As shown in FIG. 3, wireless power transmitting circuitry 34 includes an inverter such as inverter 70 or other drive circuit that produces alternating-current drive signals such as variable duty-cycle square waves or other drive signals. These signals are driven through an output circuit that includes coil(s) 36 and capacitor(s) 72 to produce wireless power signals that are transmitted wirelessly to device 10. Coil(s) 36 are electromagnetically coupled with coil(s) 14. A single coil 36 and single corresponding coil 14 are shown in the example of FIG. 3. In general, device 12 may have any suitable number of coils (1-100, more than 5, more than 10, fewer than 40, fewer than 30, 5-25, etc.) and device 10 may have any suitable number of coils. Switching circuitry (sometimes referred to as multiplexer circuitry) that is controlled by control circuitry 42 can be located before and/or after each coil (e.g., before and/or after each coil 36 and/or before and/or after the other components of output circuit 71 in device 12) and can be used to switch desired sets of one or more coils (e.g., coils 36 and output circuits 71 in device 12) into or out of use. For example, if it is determined that device 10 is located in location 62 of FIG. 2, the coil(s) 36 overlapping device 10 at location 62 may be activated during wireless power transmission operations while other coils 36 (e.g., coils not overlapped by device 10 in this example) are turned off.

Control circuitry 42 and control circuitry 20 contain wireless transceiver circuits (e.g., circuits such as wireless communication circuitry 56 and 58 of FIG. 1) for supporting wireless data transmission between devices 12 and 10. In device 10, control circuitry 20 (e.g., communications circuitry 56) can use path 91 and coil 14 to transmit data to device 12. In device 12, paths such as path 74 may be used to supply incoming data signals that have been received from device 10 using coil 36 to demodulating (receiver) circuitry in communications circuitry 58 of control circuitry 42. If desired, path 74 may be used in transmitting wireless data to device 10 with coil 36 that is received by receiver circuitry in circuitry 56 of circuitry 20 using coil 14 and path 91. Configurations in which circuitry 56 of circuitry 20 and circuitry 58 of circuitry 42 have antennas that are separate from coils 36 and 14 may also be used for supporting unidirectional and/or bidirectional wireless communications between devices 12 and 10, if desired.

During wireless power transmission operations, transistors in inverter 70 are controlled using AC control signals from control circuitry 42. Control circuitry 42 uses control path 76 to supply control signals to the gates of the transistors in inverter 70. The duty cycle and/or other attributes of these control signals and therefore the corresponding characteristics of the drive signals applied by inverter 70 to coil 36 and the corresponding wireless power signals produced by coil 36 can be adjusted dynamically.

Wireless power receiving device 10 has wireless power receiving circuitry 46. Circuitry 46 includes rectifier circuitry such as rectifier 80 (e.g., a synchronous rectifier controlled by signals from control circuitry 20) that converts received alternating-current signals from coil 14 (e.g., wireless power signals received by coil 14) into direct-current (DC) power signals for a power circuit such battery charger circuit 86 and other input-output devices 22. Battery charger circuitry 86 (e.g., a battery charging integrated circuit or other power management integrated circuit or integrated circuits) receives power from rectifier circuitry 80 and regulates the flow of this power to battery 18. One or more capacitors C are used to couple coil 14 in input circuit 90 of device 10 to input terminals for rectifier circuitry 80 such as nodes N1 and N2. Rectifier circuitry 80 may produce corresponding output power at output terminals for rectifier circuitry 80 such as nodes N3 and N4.

The amount of current Iout flowing on path 88 between rectifier circuitry 80 and battery charger circuitry 86 and the voltage Vout on path 88 can be measured by control circuitry 20 using sensor circuitry such as current sensor 82 and voltage sensor 84. Control circuitry 20 measures output power Pout from rectifier circuitry 80 by determining the product of Iout and Vout.

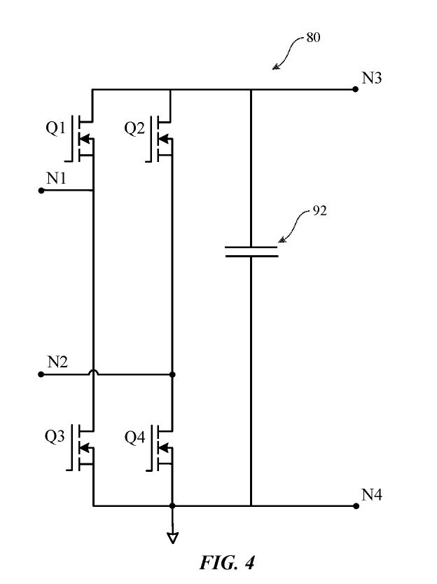

Illustrative rectifier circuitry 80 is shown in FIG. 4. As shown in FIG. 4, rectifier circuitry includes switches such as field-effect transistors Q1, Q2, Q3, and Q4 with gates that receive control signals from control circuitry 20 to implement a synchronous rectification scheme. Transistors Q1 and Q3 are coupled in series between output notes N3 and N4. Transistors Q2 and Q4 are coupled in series with each other and are coupled in parallel with transistors Q1 and Q3 between nodes N3 and N4. Capacitor 92 is coupled between nodes N3 and N4. Node N1 is between transistors Q1 and Q3. Node N2 is between transistors Q2 and Q4. Node N4 is coupled to ground. Control circuitry 20 provides the gates of transistors Q1, Q2, Q3, and Q4 with control signals that cause rectifier circuitry 80 to convert received alternating-current wireless power signals from coil 14 across nodes N1 and N2 into DC power across nodes N3 and N4.

During operation, a user places one or more devices 10 on charging surface 60 in locations such as locations 62 and 64. The position at which a device 10 is located on surface 60 affects alignment between the coil 14 in that device and coil(s) 36 in device 12. Foreign objects may also be present that affect coupling. In the event that a user shifts the position of device 10 and/or a foreign object on which device 10 might be temporarily resting, the coupling between the coils in devices 12 and 10 can vary abruptly.

To prevent damage to the circuitry of system 8 such as circuitry 46 of device 10, input circuit 90 of wireless power receiving circuitry 46 of device 10 includes protection circuitry. The protection circuitry is coupled between coil 14 and nodes N1 and N2. To prevent excessive voltages and possible damage to capacitors C of input circuit 90 that might arise from using protection circuits located between capacitors C and nodes N1 and N2, the protection circuitry of input circuit 90 includes components that are coupled to nodes located between capacitors C and coil 14. The protection circuitry includes transistors or other switches that are controlled dynamically by control circuitry 20 based on information such as current and voltage measurements from sensors 82 and 84 or other sensor circuitry. For example, protection circuitry can be switched into use in response to determining that a current or voltage measurement in device 10 has exceeded a predetermined threshold value (e.g., in response to determining that the output voltage from circuitry 80 that is measured by sensor circuitry 84) across output nodes N3 and N4 has exceeded a predetermined threshold voltage), thereby limiting currents and voltages in device 10 (e.g., by preventing undesired resonant circuits from forming that include coil 14 and capacitors C).

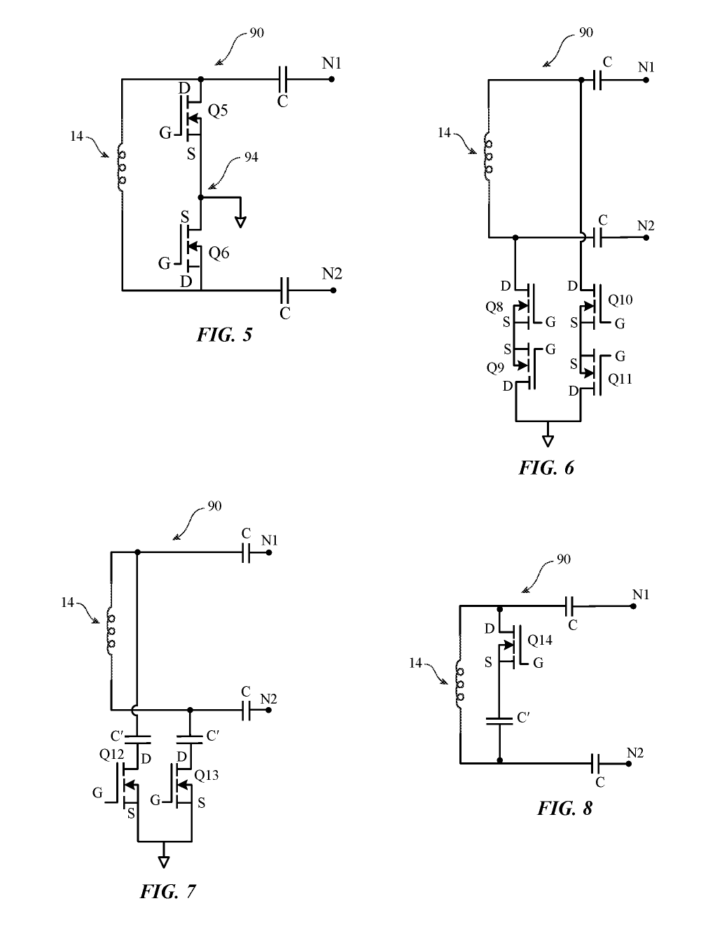

Illustrative configurations for the protection circuitry of input circuit 90 are shown in FIGS. 5, 6, 7, 8, 9, 10, 11, and 12.

In the example of FIG. 5, circuit 90 includes a pair of protection transistors Q5 and Q6 coupled in series with each other and coupled in parallel with coil 14. Transistors Q5 and Q6 are coupled in a back-to-back configuration. In a back-to-back configuration, both of the drains D of transistors Q5 and Q6 or (as shown in FIG. 5), both of the sources S of transistors Q5 and Q6 are coupled together at node 94. Node 94 can be coupled to ground or can float. During normal operation, control circuitry 20 maintains the gate-source voltage Vgs of transistors Q5 and Q6 at zero to maintain Q5 and Q6 in their off states.

The drain D of transistor Q5 is coupled to a node that is between one of the terminals of coil 14 and one of capacitors C (e.g., the capacitor C coupled to node N1). The source S of transistor Q5 is coupled to the source S of transistor Q6. The drain D of transistor Q6 is coupled to a node that is between another of the terminals of coil 14 and another of capacitors C (e.g., the capacitor C coupled to node N2). Transistors Q5 and Q6 are normally turned off. When control circuitry 20 detects excessive signal levels (current and/or voltage) in circuit 46, control circuitry 20 supplies control signals to the gates G of transistors Q5 and Q6 to turn on transistors Q5 and Q6. This couples the terminals of coil 14 together at node 94, thereby defeating the resonant circuit that would otherwise form from the coupled inductance of coil 14 and capacitance of capacitors C. If desired, node 94 may be coupled to ground.

Because transistors Q5 and Q6 shunt current from coil 14 away from capacitors C, capacitors C are not subjected to large voltages that might arise if coil 14 and capacitors C were coupled together to form a resonant circuit with a resonant frequency near to the frequency of the alternating-current signal frequency for the transmitted wireless power signals. Because capacitors C will not be subjected to large voltages, capacitors C need not be formed from excessively large and/or complex capacitor structures.

Because control circuitry 20 and the protection transistors of input circuit 90 are both located in device 10, there is minimal latency associated with controlling the protection transistors based on the sensor signals measured in device 10. There is a wireless communication latency associated with communicating wirelessly between device 10 and device 12. In situations in which the wireless power transmission of device 12 is to be adjusted (e.g., due to changes in coupling coefficient), both local changes to the protection circuitry of input circuit 90 and changes to the operation of device 12 that are communicated wirelessly from device 10 to device 12 can be made. The protection circuitry can be controlled by control circuitry 20 in device 10 to implement rapid changes in device 10 to prevent circuit damage. Changes that are to be made by transmitting device 12 can be communicated wirelessly between device 10 and device 12.

The arrangement of FIG. 6 uses four protection transistors: Q8, Q9, Q10, and Q11. Transistors Q8 and Q9 are coupled in series (e.g., in a back-to-back configuration) between a first of the terminals of coil 14 and ground. Transistors Q10 and Q11 are coupled in series (e.g., in a back-to-back configuration) between a second of the terminals of coil 14 and ground. When it is desired to defeat the resonance that would otherwise arise from the series coupling of the inductance of coil 14 and the capacitance of capacitors C, the protection transistors Q8, Q9, Q10, and Q11 may be turned on by control circuitry 20.

Another illustrative configuration for the protection circuitry of input circuit 90 is shown in FIG. 7. In the arrangement of FIG. 7, a first of the terminals of coil 14 is coupled to ground through a first capacitor C′ and transistor Q12 and a second of the terminals of coil 14 is coupled to ground through a second capacitor C′ and transistor Q13. Capacitors C′ are smaller than capacitors C, so the impedance of capacitors C′ at the frequency of the wireless power signals will be less than that of capacitors C and less voltage will drop across capacitors C′ than capacitors C. The capacitance of capacitors C′ is also selected so that the inductance of coil 14 and the capacitance of capacitors C′ will not be associated with a resonant frequency that is equal to or nearly equal to the frequency of the wireless power signals transmitted by device 12.

FIG. 8 shows how resonance of coil 14 and capacitors C can be defeated during circuit protection operations by turning on a single transistor Q14. Transistor Q14 is coupled in series with capacitor C′ between first and second terminals of coil 14.

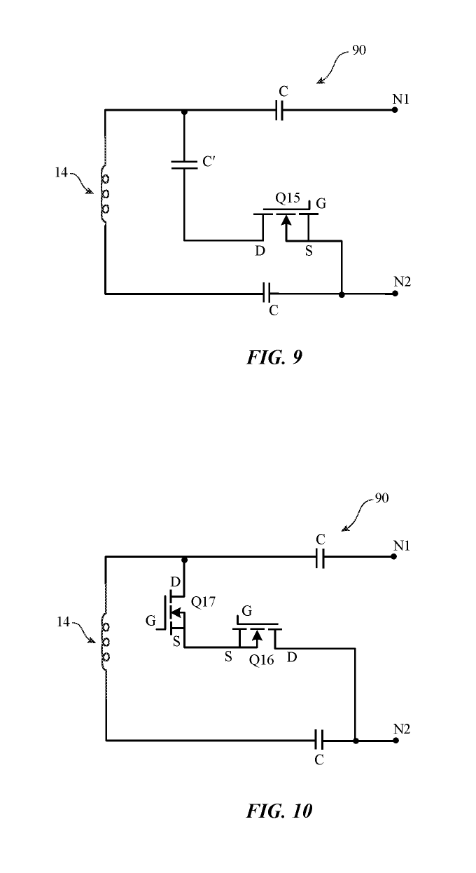

Another illustrative protection scheme based on a single protection transistor in input circuit 90 is shown in FIG. 9. In the arrangement of FIG. 9, transistor Q15 and capacitor C′ are coupled in series across coil 14. Capacitor C′ has a first terminal coupled to a node between a first of capacitors C and coil 14. Capacitor C′ has a second terminal coupled to a first terminal of transistor Q15 (e.g., drain D). A second terminal of transistor Q16 (e.g., source S) is coupled to node N2. Resonance between coil 14 and capacitors C can be defeated by turning transistor Q15 on (e.g., when control circuitry 20 detects excessive voltage with voltage sensor 84). Transistor source and drain terminals such as terminals S and D of transistor Q15 and the other transistors of input circuit 90 and rectifier circuitry 80 may sometimes be collectively referred to herein as source-drain terminals.

FIG. 10 shows how a pair of transistors (e.g., back-to-back transistors Q16 and Q17) can be coupled across coil 14 and one of capacitors C. Resonance between coil 14 and capacitors C can be defeated by turning transistors Q16 and Q17 on (e.g., when control circuitry 20 detects excessive voltage with voltage sensor 84).

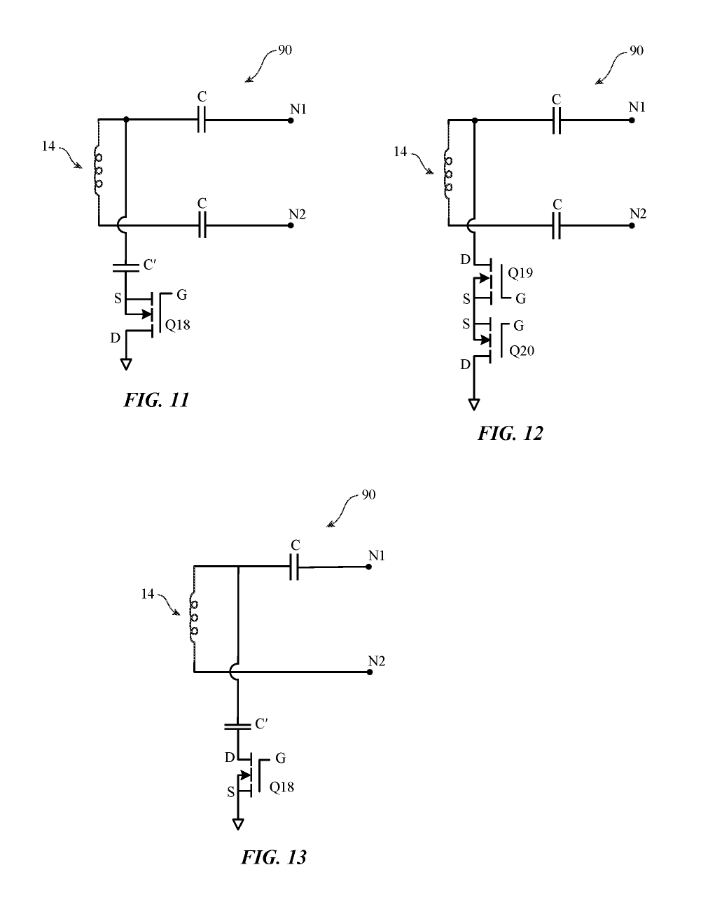

In the configuration of FIG. 11, a node located between coil 14 and one of capacitors C can be selectively coupled to ground through series-connected capacitor C′ and transistor Q18.

In the configuration of FIG. 12, a pair of transistors Q19 and Q20 are coupled in series between a node located between coil 14 and one of capacitors C. Transistors Q19 and Q20 of FIG. 12 are coupled in a back-to-back configuration in which the source S of transistor Q19 is coupled to the source S of transistor 20. Other configurations may be used, if desired. For example, one of the capacitors C can be omitted from the circuit of FIG. 11 as shown in FIG. 13, one of the capacitors C can be omitted from the circuit of FIG. 12, and/or the other input circuits 90 may contain only a single capacitor C rather than a pair of capacitors C. In the illustrative singled-ended configuration of FIG. 13, capacitor C between node N2 and coil 14 of FIG. 11 has been omitted so that node N1 is directly connected to coil 14 without any intervening capacitors and a single transistor Q18 is used in the protection circuitry. Transistor Q18 has one source-drain terminal coupled to ground and another source-drain terminal coupled to a first terminal of capacitor C′. Capacitor C′ has a second terminal coupled to the node between coil 14 and capacitor C.

The foregoing is illustrative and various modifications can be made to the described embodiments. The foregoing embodiments may be implemented individually or in any combination.

What is claimed is:

1. A wireless power receiving device configured to receive wireless power signals transmitted from a wireless power transmitting device, the wireless power receiving device comprising:
a wireless power receiving coil configured to receive the wireless power signals, wherein the wireless power receiving coil has first and second terminals;
rectifier circuitry that has first and second input terminals and that is configured to supply output power at corresponding first and second output terminals based on the received wireless power signals;
a first capacitor coupled to the first input terminal;
a second capacitor coupled to the second input terminal; and
protection circuitry that includes a first transistor coupled to a node between the first capacitor and the first terminal of the wireless power receiving coil and that includes a second transistor coupled to a node between the second capacitor and the second terminal of the wireless power receiving coil.

2. The wireless power receiving device of claim 1 wherein the first and second transistors are coupled in series between the first and second terminals of the wireless power receiving coil.

3. The wireless power receiving device of claim 2 wherein the first and second transistors are coupled together in a back-to-back configuration.

4. The wireless power receiving device of claim 3 wherein the first and second transistors are coupled together at a ground node.

5. The wireless power receiving device of claim 1 further comprising control circuitry configured to control the first and second transistors.

6. The wireless power receiving device of claim 5 further comprising sensor circuitry coupled to the first and second output terminals, wherein the control circuitry is configured to turn on the first and second transistors in response to determining that a signal measured with the sensor circuitry exceeds a predetermined threshold.

7. The wireless power receiving device of claim 5 wherein the sensor circuitry comprises a voltage sensor and wherein the control circuitry is configured to turn on the first and second transistors in response to determining that a voltage measured with the voltage sensor exceeds a predetermined voltage threshold.

8. A wireless power receiving device configured to receive wireless power signals transmitted from a wireless power transmitting device, the wireless power receiving device comprising:
a wireless power receiving coil configured to receive the wireless power signals, wherein the wireless power receiving coil has first and second terminals;
rectifier circuitry that has first and second input terminals and that is configured to supply output power at corresponding first and second output terminals based on the received wireless power signals;
a capacitor having a first terminal coupled to the first input terminal and having a second terminal coupled to the first terminal of the wireless power receiving coil at a node;
protection circuitry coupled to the node, wherein the protection circuitry includes at least one transistor;
sensor circuitry coupled to the first and second output terminals; and
control circuitry configured to control the at least one transistor based on information from the sensor circuitry.

9. The wireless power receiving device of claim 8 wherein the second output terminal is coupled to a ground terminal and wherein the at least one transistor comprises a pair of transistors coupled between the node and the ground terminal.

10. The wireless power receiving device of claim 9 wherein the pair of transistors comprises first and second transistors coupled in a back-to-back configuration.

11. The wireless power receiving device of claim 8 wherein the at least one transistor comprises first and second pairs of transistors and wherein the first pair of transistors is coupled to the node.

12. The wireless power receiving device of claim 11 wherein the second pair of transistors is coupled to the second terminal of the wireless power receiving coil.

13. The wireless power receiving device of claim 8 wherein the second output terminal is coupled to a ground terminal and wherein the protection circuitry comprises a capacitor having a first terminal coupled to the node and a second terminal coupled to a first terminal of the at least one transistor of the protection circuitry, and wherein the at least one transistor of the protection circuitry has a second terminal coupled to the ground terminal.

14. The wireless power receiving device of claim 8 further comprising a capacitor coupled between the second terminal of the wireless power receiving coil and the second input terminal.

15. The wireless power receiving device of claim 14 wherein the protection circuitry comprises a pair of transistors coupled across the wireless power receiving coil between the first and second terminals.

16. The wireless power receiving device of claim 15 wherein the protection circuitry comprises a first transistor coupled between a ground terminal and the first terminal and a second transistor coupled between the ground terminal and the second terminal.

17. The wireless power receiving device of claim 8 wherein the protection circuitry comprises at least one capacitor.

18. A wireless power receiving device configured to receive wireless power signals transmitted from a wireless power transmitting device, the wireless power receiving device comprising:
a wireless power receiving coil configured to receive the wireless power signals;
rectifier circuitry that has input terminals and that is configured to supply output power at corresponding output terminals based on the received wireless power signals;
at least one capacitor coupled between one of the input terminals and the wireless power receiving coil;
protection circuitry coupled to a node between the wireless power receiving coil and the capacitor, wherein the protection circuitry includes at least one transistor; and
control circuitry configured to control the transistor.

19. The wireless power receiving device of claim 18 further comprising:
sensor circuitry coupled to the output terminals, wherein the control circuitry is configured to turn on the transistor based on a measurement from the sensor circuitry.

20. The wireless power receiving device of claim 19 wherein the at least one transistor comprises first and second transistors coupled in series across the wireless power receiving coil, wherein the at least one capacitor comprises first and second capacitors, wherein the first capacitor is coupled between a first node and a first of the input terminals, wherein the second capacitor is coupled between a second node and a second of the input terminals, wherein the wireless power receiving coil has first and second terminals, wherein the first terminal of the wireless power receiving coil and the first transistor are coupled to the first node, and wherein the second terminal of the wireless power receiving coil and the second transistor are coupled to the second node.

21. A wireless power receiving device configured to receive wireless power signals transmitted from a wireless power transmitting device, the wireless power receiving device comprising:
a wireless power receiving coil configured to receive the wireless power signals, wherein the wireless power receiving coil has first and second terminals;
rectifier circuitry that has first and second input terminals and that is configured to supply output power at corresponding first and second output terminals based on the received wireless power signals;
a capacitor having a first terminal coupled to the first input terminal of the rectifier circuitry and having a second terminal coupled to the first terminal of the wireless power receiving coil at a node; and
protection circuitry coupled to the node, wherein the protection circuitry includes a transistor.

22. The wireless power receiving device of claim 21 wherein the second output terminal is coupled to a ground terminal, wherein the transistor has first and second terminals, and wherein the second terminal of the transistor is coupled to the ground terminal.

23. The wireless power receiving device of claim 22 wherein the protection circuitry further comprises a capacitor having a first terminal coupled to the node and a second terminal coupled to the first terminal of the transistor.

24. The wireless power receiving device of claim 23 further comprising:
sensor circuitry coupled to the first and second output terminals; and
control circuitry configured to control the transistor based on information from the sensor circuitry.

25. The wireless power receiving device of claim 24 wherein the second input terminal is directly connected to the second terminal of the wireless power receiving coil.
